(19) United States
(12) Patent Application Publication
(10) Pub. No.: US 2015/0153998 A1
(43) Pub. Date: Jun. 4, 2015

(54) Systems and methods for providing music

(71) Applicant: Francisco Jesus Iglesias Megias, Escaldes Engordany (AD)

(72) Inventor: Francisco Jesus Iglesias Megias, Escaldes Engordany (AD)

(21) Appl. No.: 14/121,257

(22) Filed: Aug. 14, 2014

Related U.S. Application Data
(60) Provisional application No. 61/959,073, filed on Aug. 14, 2013.

(51) Int. Cl. G06F 3/16; H04L 29/06; H04L 29/08

(52) U.S. Cl. CPC G06F 3/165; H04L 67/10; H04L 65/60

(57) ABSTRACT

A method of providing music includes creating a playlist of songs capable of being played at an establishment, the playlist accessible via a wireless network by users, providing users with access to the playlist of songs via the wireless network, receiving user votes via the wireless network indicating which songs from the playlist of songs users desire to hear and updating an order of songs to be played at the establishment based on the user votes.

### REFERENCE TO RELATED APPLICATION

The present disclosure is based on and claims benefit from U.S. Provisional Application Ser. No. 61/959,073 filed on Aug. 14, 2013, the entire contents of which are herein incorporated by reference.

### BACKGROUND

1. Technical Field

The present disclosure relates generally to music and, more particularly, to systems and methods for providing music.

2. Description of the Background Art

It is generally believed that music in one form or another has been around for over fifty thousand years. Over the course of mankind, many ways have been developed to deliver music to others. For example, music has been delivered over the air waves via radio. Music has also been delivered to the masses via recordings (e.g., reel to reel, records, eight track, cassette, CD . . . etc.) Today, music is easily sold, shared or otherwise distributed via the World Wide Web.

Establishments have used various types of delivery systems to provide music to patrons. For example, coin-operated music boxes and player pianos were among the first forms of coin-operated musical devices and used mechanical mechanisms to actually play one or more instruments. Later, machines were developed to play recordings instead of the physical instruments. These early machines were generally capable of playing only one tune. Improvements eventually led to machines capable of playing many tunes. These machines are known as Jukeboxes and were capable of manipulating and playing individual records (e.g., 78 rpm records or 45 rpm records). Early jukeboxes included song counters for counting the number of times each song was played. In this way, less played songs could be replaced with different ones. A patron simply inserted the required currency into the slot and made one or more musical selections which then played in the order selected.

Today, with the internet and technological improvements in music playing equipment, there are various types of systems available to an establishment for providing musical entertainment to its patrons.

Some of the systems presently available include IJUKEBOX, PAYITAPP, PLAYMYSONG, SETLIST, ROQBOC, HIVEPLAY, NOISPOST, SPOTIFY PREMIUM. With some of these systems, complicated intellectual property rights must be monitored and respected. These systems generally use their own music and/or sell their music to the establishments. Some of the present systems allow a user through use of an app, to send a song request, listen to the song at the establishment sometimes for free or sometimes for a fee. However, the selected songs are generally played following the order in which they were requested. In some present systems, the songs requested are played when the manager of the establishment decides.

There is a need for a music playing system and method capable of letting an establishment utilize their own music while allowing patrons to interact with the music selection process at the establishment.

### SUMMARY

This application describes tools (in the form of methodologies, apparatuses, and systems) for providing music. The tools may be embodied in one or more computer programs stored on a computer readable medium or program storage device and/or transmitted in the form of a computer data signal in one or more segments via a computer network or other transmission medium.

A method of providing music comprises creating a playlist of songs capable of being played at an establishment, the playlist accessible via a wireless network by users, providing users with access to the playlist of songs via the wireless network, receiving user votes via the wireless network indicating which songs from the playlist of songs users desire to hear and updating an order of songs to be played at the establishment based on the user votes.

A system of providing music comprises a system for creating a playlist of songs capable of being played at an establishment, the playlist accessible via a wireless network by users, a system for providing users with access to the playlist of songs via the wireless network, a system for receiving user votes via the wireless network indicating which songs from the playlist of songs users desire to hear and a system for updating an order of songs to be played at the establishment based on the user votes.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1A-1D show a website developed according to embodiments of the present disclosure;

FIGS. 2A-2C show Login screens according to embodiments of the present disclosure;

FIG. 3A shows a Venue List screen according to an embodiment of the present disclosure;

FIG. 3B shows an access screen to private party playlists according to an embodiment of the present disclosure;

FIG. 4 shows a Playlist screen according to an embodiment of the present disclosure;

FIG. 5A-5E show Map screens and associated screens according to an embodiment of the present disclosure;

FIG. 6 shows a Share screen according to an embodiment of the present disclosure;

FIG. 7A-7C show User Profile Information screens according to an embodiment of the present disclosure;

FIG. 8 shows a computer system capable of implementing aspects of the present disclosure;

FIG. 9 shows a flowchart for describing steps performed by Venues according to embodiments of the present disclosure;

FIG. 10 shows a flowchart for describing steps performed by users according to embodiments of the present disclosure;

FIG. 11 shows an implementation according to an embodiment of the present disclosure;

FIG. 12 further shows an implementation according to an embodiment of the present disclosure; and

FIGS. 13A-13C show various screen shots allowing Venues to utilize various embodiments of the present disclosure.

### DETAILED DESCRIPTION

The following exemplary embodiments are set forth to aid in an understanding of the subject matter of this disclosure, but are not intended, and may not be construed, to limit in any way the subject matter which follows thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

Embodiments of the present disclosure improve the experience of patrons in Venues (e.g., business establishments, etc.) where music is played, and encourages them to stay longer and thus increase their purchases. In addition, embodiments of the present disclosure help clients and subscribers (e.g., bars, pubs, restaurants, clubs, hotels, gyms, shopping centers, etc.) to build a personal relationship with their patrons in a different and revolutionary way at a reduced cost and ensuring maximum added value for their businesses.

According to an embodiment of the present disclosure, a system is provided that lets patrons vote for songs they would like to hear at an establishment or Venue. An embodiment of the present disclosure utilizes music owned by the establishments and deals only with the tracks of music that the establishment owns. In this way, there are no complicated intellectual property rights to monitor. The song having the most votes is played automatically. Once the song ends, its vote count is set to zero and the song then having the most votes is played. This process is repeated.

According to an embodiment of the present disclosure an establishment provides its patrons with a playlist of music capable of being played during their visit to the establishment. According to an embodiment, the establishment's playlist can be accessed via the Internet and viewed on a portable computing device such as, for example, a smartphone. Whenever a user or consumer wishes to interact with the establishment, they can access its playlist through a free mobile application on their smartphone and start voting for their favorite songs utilizing the application. The song with the most user votes will be shown at the top of a list (e.g., playlist) and will be the one that is played first. According to an embodiment of the present disclosure, the manager of the Venue can change the playlist as desired in a matter of seconds. In this way, the manager can change the atmosphere of the Venue if so desired.

Accordingly, embodiments of the present disclosure allow the patrons of the Venues to decide on the order in which the songs are played, thus allowing the patrons to create their favorite atmosphere in a democratic way, within the confines of the songs in the playlist provided by the establishment.

Users (e.g., patrons) download an application (e.g., an app) developed according to embodiments of the present disclosure to their portable device (e.g., phone, tablet, laptop computer, etc.) The app is then used to locate Venues or establishments that make use of embodiments of the present disclosure. A list of Venues can be provided in a formal list or the Venues can be located and displayed on a map. The results may be filtered depending on the style of music or the type of establishment. After selecting a Venue, if they are close enough to it, users can access that Venue's playlist in order to start voting for their preferred songs. Embodiments of the present disclosure may also be shared via one or more of the social networks.

A website according to an embodiment of the present disclosure is a communications tool and is designed to generate downloads of the app and awaken interest in customers to utilize tools created according to embodiments of the present disclosure. The website also allows clients access to their Venue's profile information and playlists.

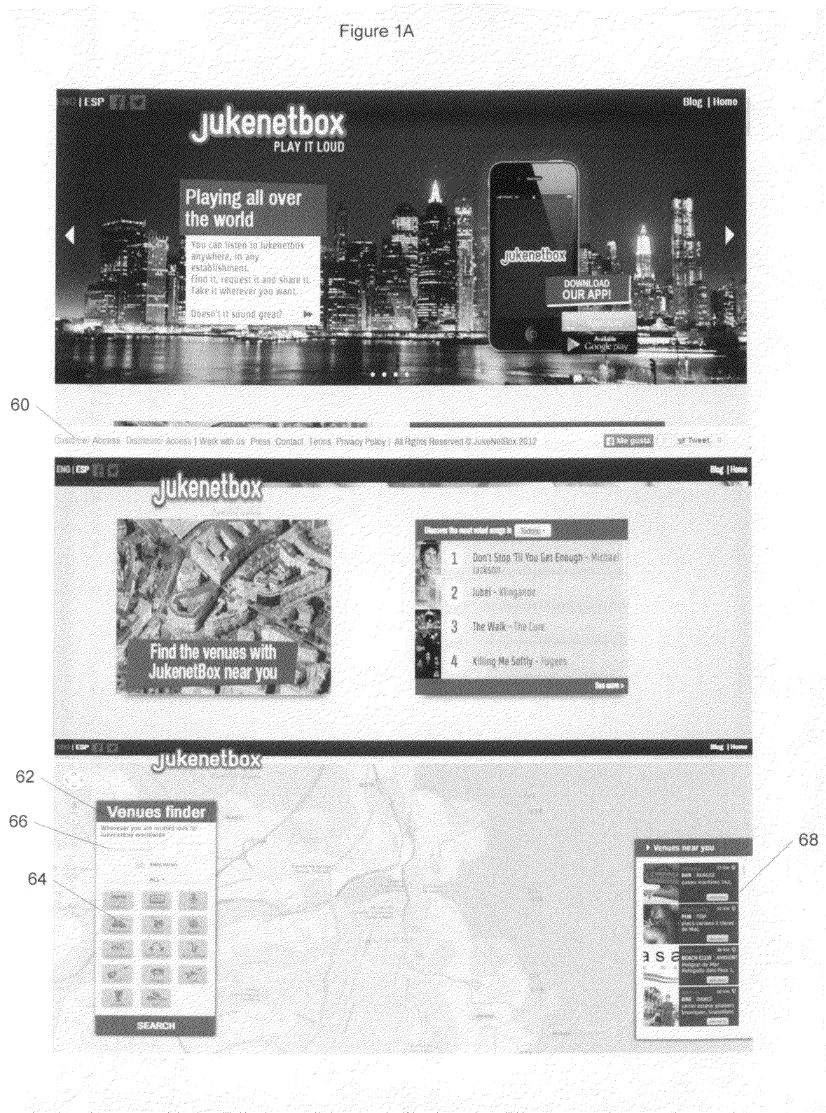

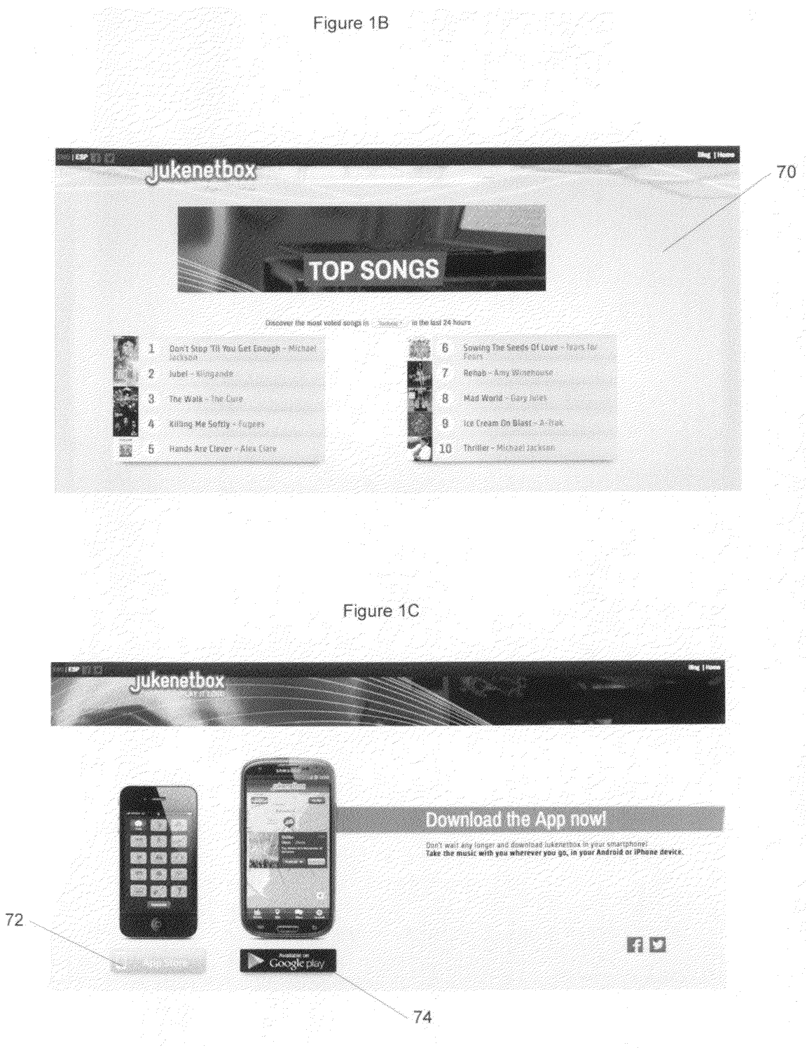

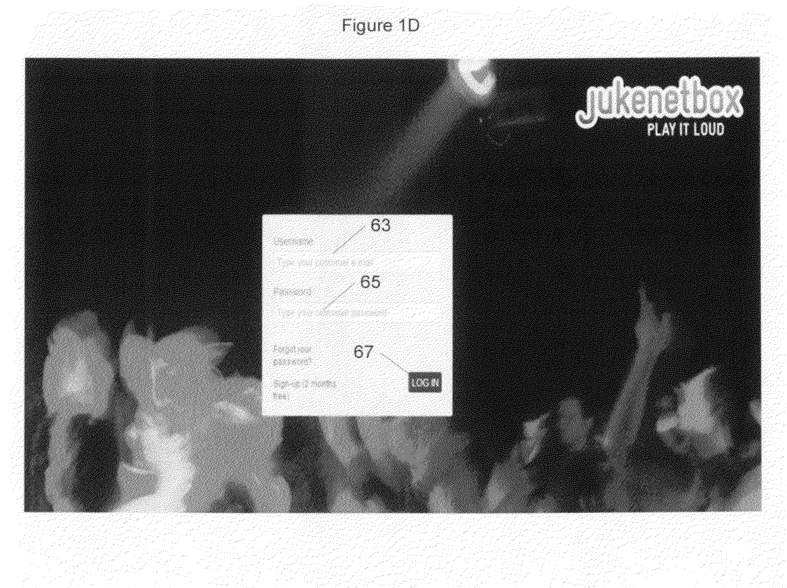

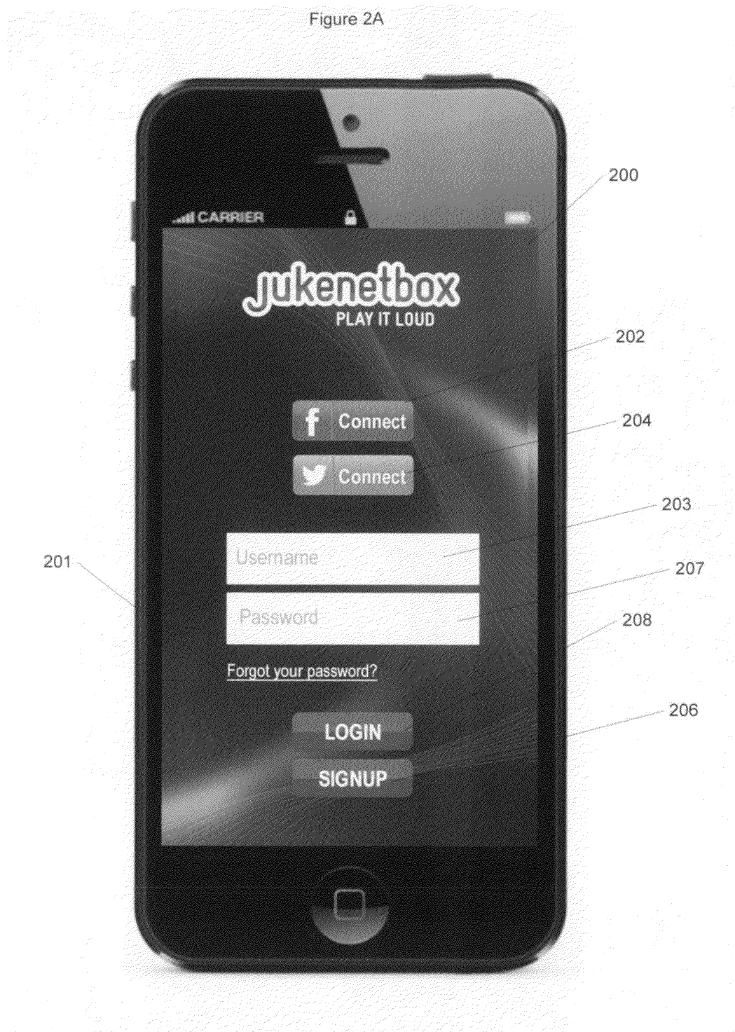

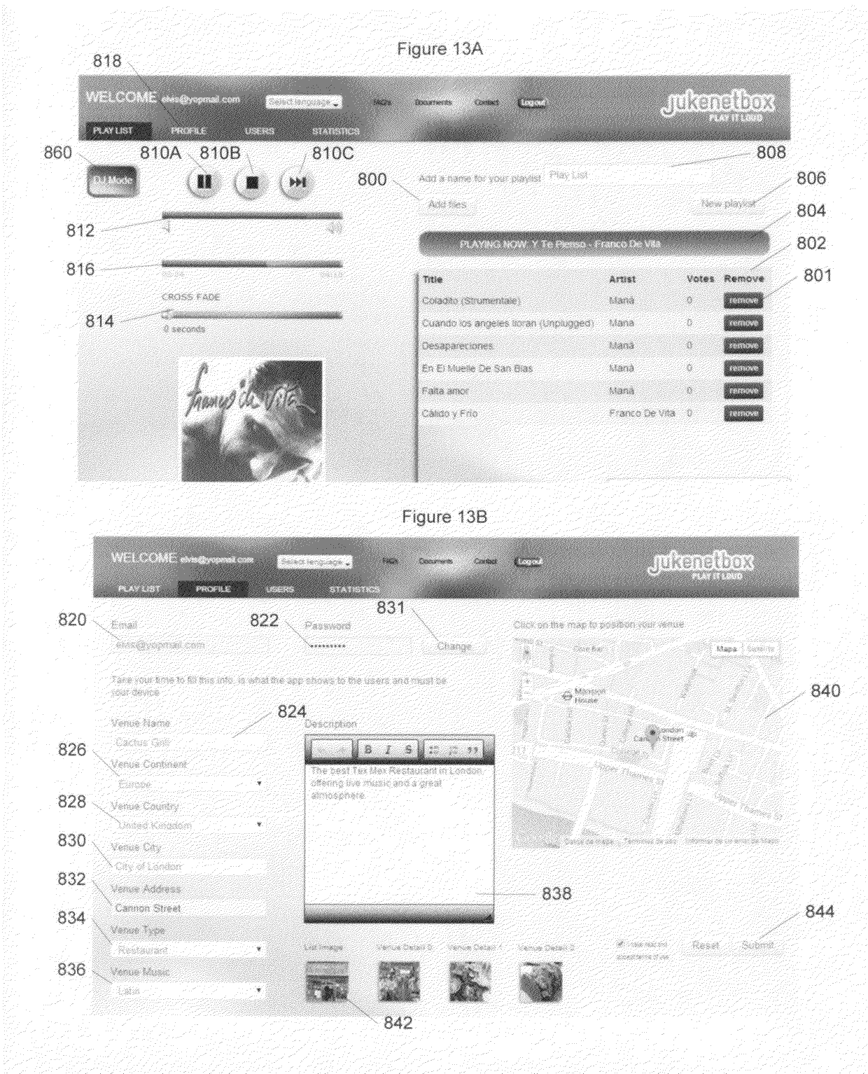

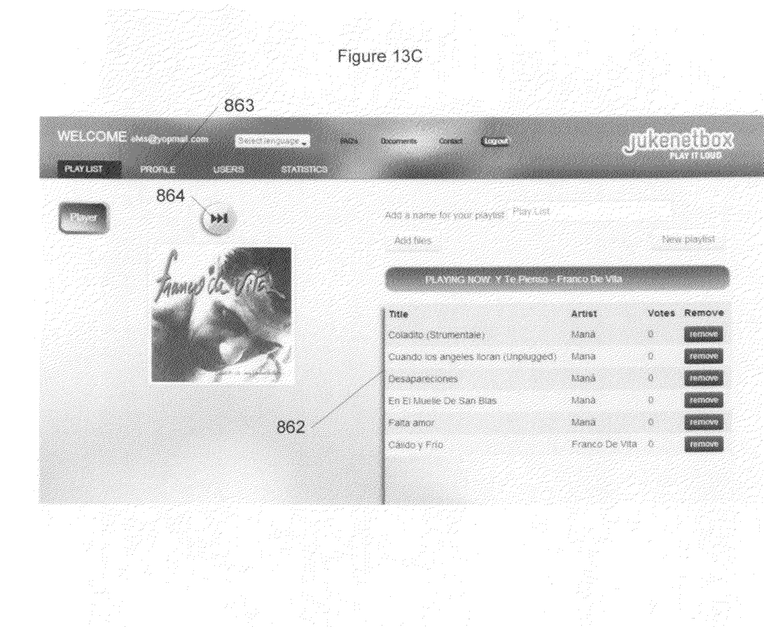

An example of a Website developed according to an embodiment of the present disclosure is shown in FIGS. 1A-1D. Clicking Customer Access area 60 of the website allows Venues to access their profile and playlist and will display a login screen such as that shown in FIG. 1D. After entering their email address (63) and password (65) and clicking Log In button 67, a screen such as that shown in FIG. 13A will be provided allowing the Venue to create/modify playlists and manage their profile. Venues Finder area 62 allows users to enter a specific location (e.g., town, county, zip code, street, etc.) into box 66 to search for local Venues utilizing aspects of the present disclosure. Area 62 also includes a number of buttons 64, each labeled with a particular type of music (e.g., dance, jazz, country, rock, etc.) The search for Venues can be filtered by the type of music desired by clicking the appropriate button or buttons 64. Area 68 displays a list of local Venues returned as a result of the search. As shown in FIG. 1B, area 70 displays a list of songs most highly voted for and/or listened to. Clicking on area 72 or 74 (FIG. 1C) allows users to download apps (e.g., mobile apps) according to embodiments of the present disclosure.

Embodiments of the present disclosure provide salient benefits over systems presently available. For example, according to an embodiment of the present disclosure, the music (e.g., songs or tracks) utilized is already in the possession of or accessible by each establishment utilizing the present system. Accordingly, each establishment is free to make use of its own style of music with no limits. The music can be streamed from the cloud or provided via any kind of software and/or hardware. In addition, according to embodiments of the present disclosure, use of embodiments of the present disclosure can be made completely free to the final consumer. For example, the system can be arranged so that no payment is made for downloading the application or for voting. Of course, the system could be arranged to charge a fee or fees if desired. Embodiments of the present disclosure also allow business plans to include diverse forms of economic development during different project phases. The present disclosure also makes it possible to operate in any country in the world from the very first day, with no legal conflicts arising from authors' rights over the music.

The present disclosure provides for the democratization of music since it gives users complete freedom to choose the music they want to hear while also respecting the musical style of each Venue. The present disclosure helps clients and subscribers (e.g., Venues such as bars, pubs, restaurants, clubs, hotels, gyms, shopping centers, etc.) to build a personal relationship in a different and revolutionary way at a reduced cost and ensuring maximum added value for their businesses. Embodiments of the present disclosure provide a way for attracting new clients and retaining their loyalty in any establishment that plays music.

Furthermore, embodiments of the present disclosure eliminate the effort of preparing playlists for businesses in which music has added value, thus optimizing the time devoted to this task by the establishments and improving the personal experiences of consumers.

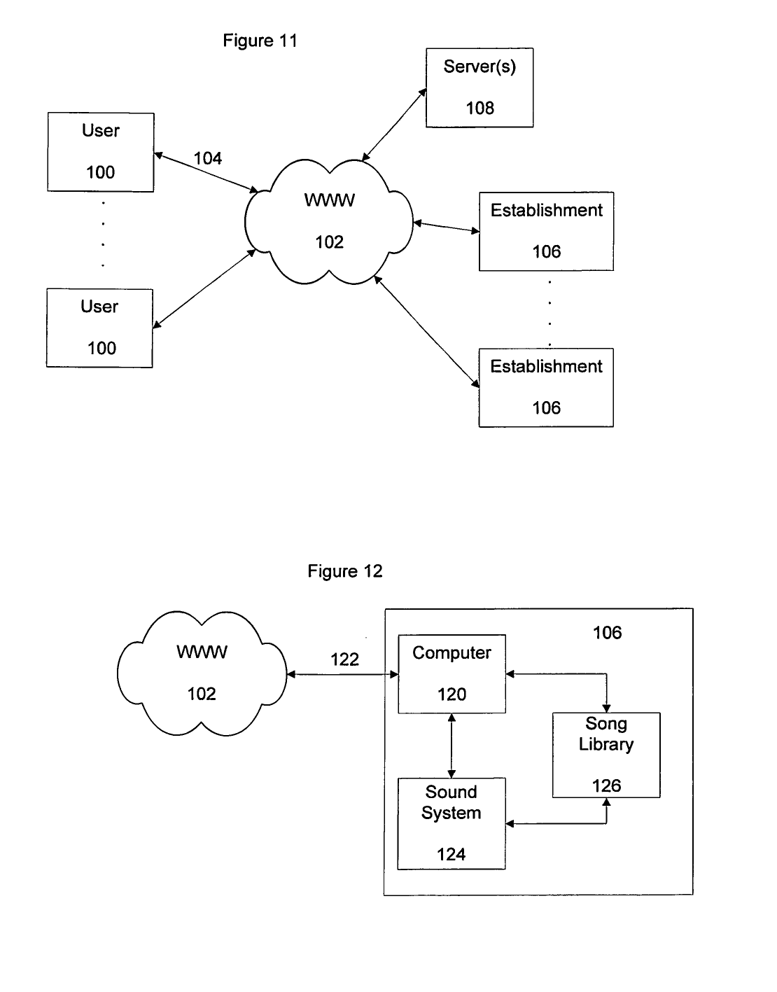

FIG. 11 depicts an implementation according to an embodiment of the present disclosure. One or more establishments 106 (e.g., Venues) each compile their own playlist of music on one or more servers(s) 108 via the World Wide Web 102 utilizing any suitable type of Internet connection. The internet connection can be wired or wireless as desired. Users 100 access a Venue's playlist from server(s) 108 via their smartphone utilizing an app developed according to an embodiment of the present disclosure, for example, and then vote for songs on the playlist. An application developed according to embodiments of the present disclosure and running online over the internet and/or on the Venue's 106 computer system can then automatically pull the vote information periodically from server or servers 108. In the alternative, voter information can be automatically pushed periodically to the Venue's computer system. All user votes are tallied and the Venue's playlist is updated to reflect the vote count with the song having the most votes at the top of the playlist and the song having the least votes at the bottom of the playlist. The song having the most votes is played at the Venue. The updated playlist for the Venue is then resent to server(s) 108 where it can be resent to users 100. The updated playlist can periodically be pushed to the user's 100 mobile device or periodically pulled by the user's 100 mobile device as desired.

FIG. 12 depicts an implementation according to an embodiment of the present disclosure. According to this embodiment, an establishment's computer system 120 is connected to the Internet 102 via an internet connection 122. The internet connection 122 may be wired or wireless and is not limited to any particular type of connection. The implementation also includes a sound system 124 having access to a song library 126. Song library 126 may be a digital library of songs or may be a collection of records, tapes, CDs, music stream, etc. provided, for example, in a jukebox type of arrangement and interfaced to play music as instructed by computer system 120 or any other type of hardware and/or software system. The sound system 124 may be one capable of accessing digital music from a database and capable of playing digital music streamed on the internet and accessed either directly or by computer system 120. The sound system 124 and or song library 126 may be part of computer system 120 or may be implemented in separate hardware and/or software and capable of communicating via wired or wireless connection. The computer system 120 may include one or more software applications provided according to embodiments of the present disclosure.

Utilizing an app developed according to one or more embodiments of the present disclosure and provided on a device (e.g., a mobile device such as a smartphone), a user accesses a website developed according to embodiments of the present disclosure and is provided with a list of establishments utilizing the presently disclosed system. Once the user 100 has decided on an establishment, they can access a playlist associated with the establishment using an app provided on their device. The user can then vote for their favorite song or songs on the playlist if they are close enough to the Venue. According to an embodiment, an establishment or Venue can create multiple playlists each having one or more different songs. According to this embodiment, when a manager of the Venue wants to make a change to the music being played, they can replace the playlist currently playing with another playlist. According to another embodiment, the one playlist is utilized. When a manager of the Venue wants to make a change to the music being played, they can modify the playlist as desired by adding and removing songs from the playlist. As users 100 vote, the songs having the most votes will appear at the top of the playlist. The songs will then play in order, with the song having the most votes playing first, the song with the next most votes playing second, etc.

The embodiments of the present disclosure thus allow the patrons of an establishment to democratically create the musical atmosphere they desire, within the confines of the musical selections made available by the establishment. The present systems and methods enable users to decide on the order of the songs in the playlists in a democratic way.

Social networks may also be utilized according to various embodiments of the present disclosure. For example, friends may invite their friends utilizing a social network such as FACEBOOK, for example, to meet them at an establishment and ask them to vote for their favorite songs.

Embodiments of the present disclosure will be described by reference to their use on a mobile device such as a smartphone. Of course, the present disclosure is not limited to such devices and may be utilized on any type of computer system including PCs, laptop computers, any type of mobile device, tablet, etc. capable of accessing the interne via wired or wireless connection.

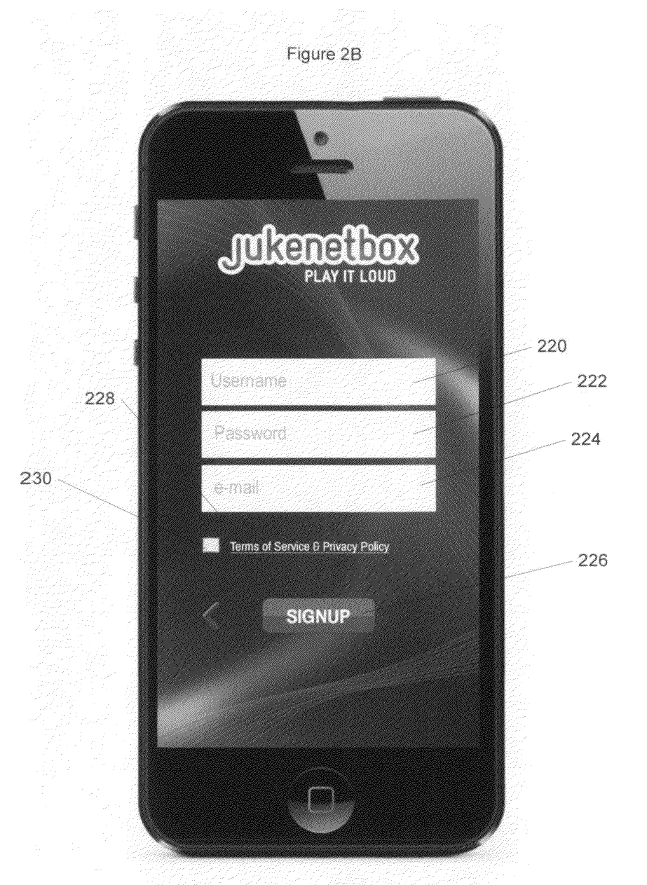

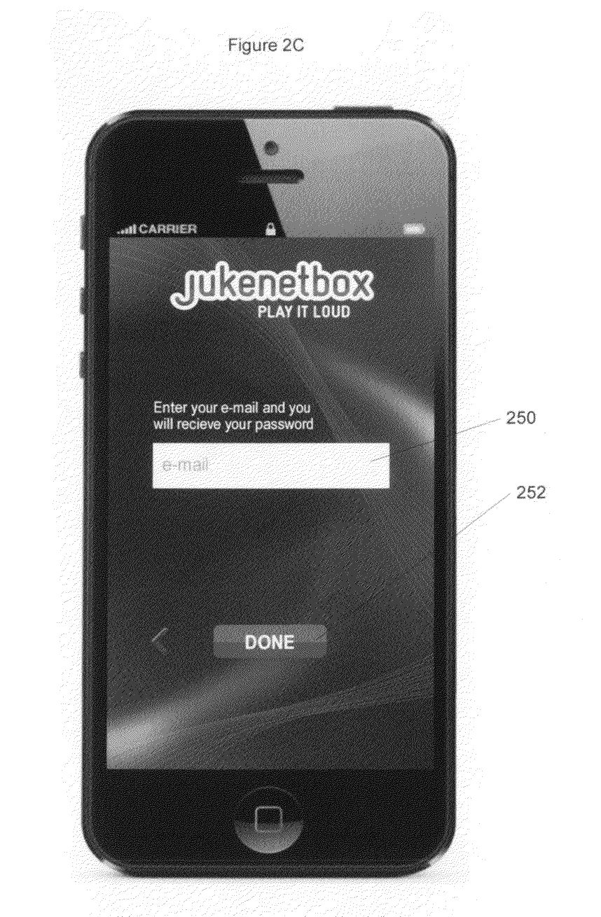

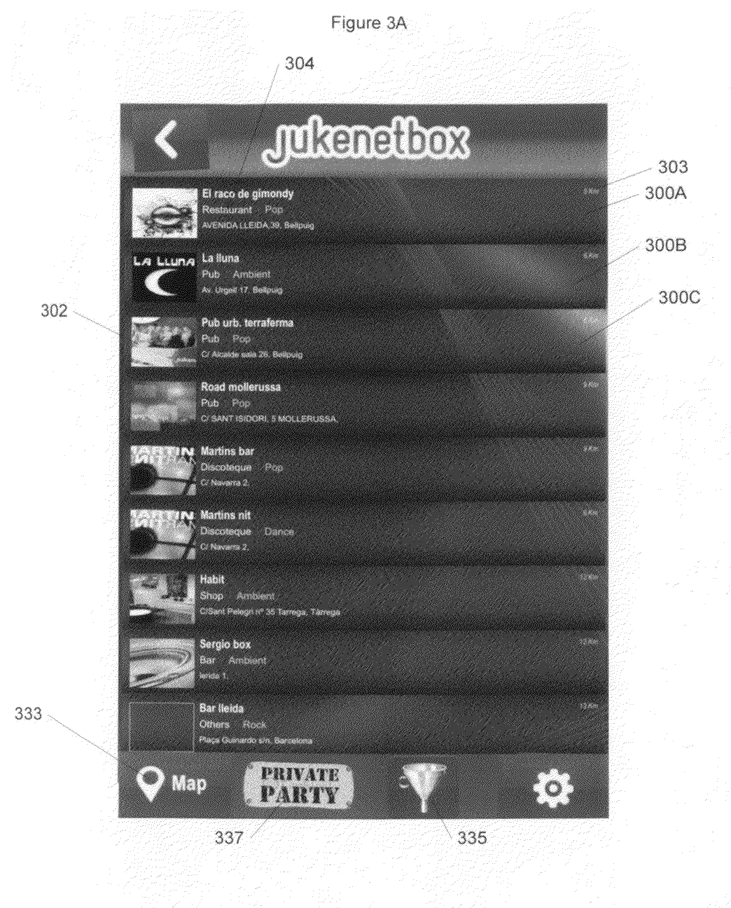

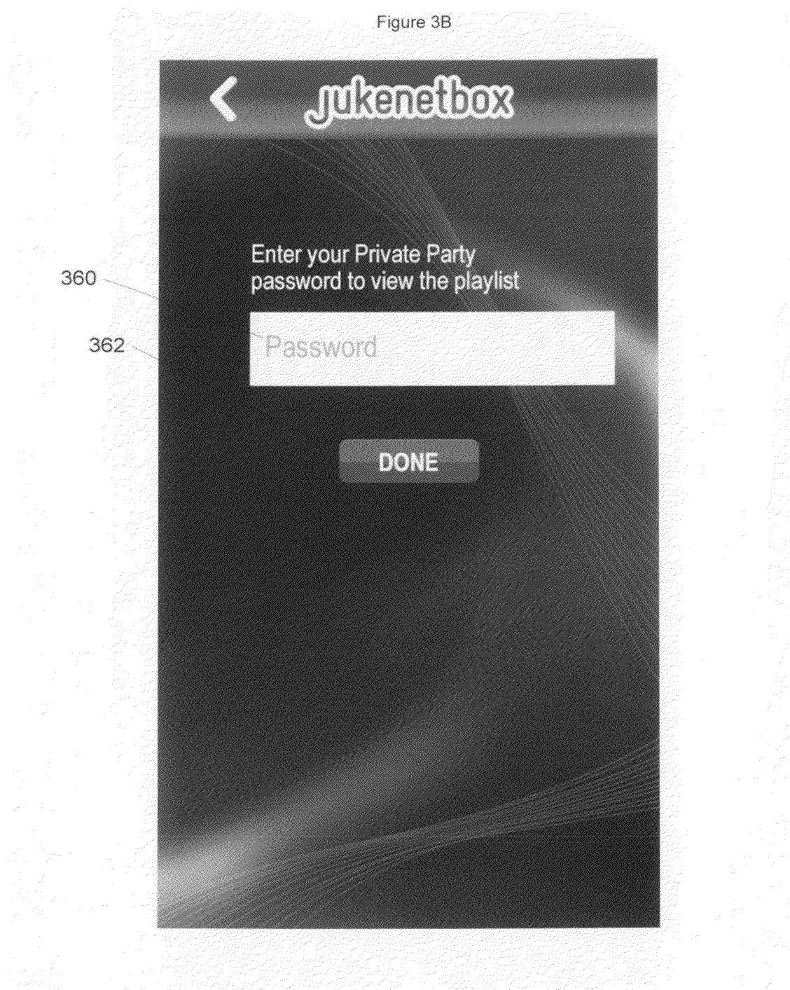

After downloading the app, the user is presented with a login screen. FIG. 2A depicts a LOGIN screen 200 according to an embodiment of the present disclosure. Utilizing Login screen 200, the user can access the app as a Facebook or Twitter user, by clicking Facebook button 202 or Twitter button 204, respectively. In the alternative, the user can choose to access the app as a user utilizing an access screen set up according to an embodiment of the present disclosure. In the example shown in FIG. 2A, the access screen is referred to as JUKENETBOX. The user can sign up to JUKENETBOX by selecting signup button 206. After selecting signup button 206, the user is presented with one or more screens for signing up. An example of such a Signup screen is shown in FIG. 2B. The user enters a User Name (box 220), Password (box 222) and email address (box 224) and clicks Signup button 226. According to an embodiment of the present disclosure, prior to being allowed to sign up, the user is prompted to review the Terms of Service and Privacy Policy by clicking link 228. After review, the user can check box 230 indicating their consent to the terms. The user can then click Signup button 226 to proceed. Clicking Forgot Your Password? button 201 (FIG. 2A), the user is presented with a screen such as that shown in FIG. 2C. The user enters their email address in box 250 and clicks Done button 252. The user's password is then automatically forwarded to the user's email address provided. Returning to FIG. 2A, after the user has signed up, they can access the JUKENETBOX site by entering their email address (box 203) and password (box 207) and clicking Login button 208. After the email address and password information is verified, the user is presented with a Venue List screen such as that shown in FIG. 3A.

FIG. 3A depicts a Venue List screen according to an embodiment of the present disclosure. Utilizing geo-localization the Venues closest to the user's position are listed. According to an embodiment of the present disclosure, the app locates the position of the user and informs the user about Venues in their vicinity. For example, the user may be located utilizing GPS, IP, Cell-ID and or WiFi systems. Parameters for the distance of the Venues from the user can be modified and, depending on the distance, allow the user to view the playlist of the Venue but will not allow the user to vote unless the user is within a defined distance from the Venue. In this way, only users that are actually interacting at or near the Venue may vote.

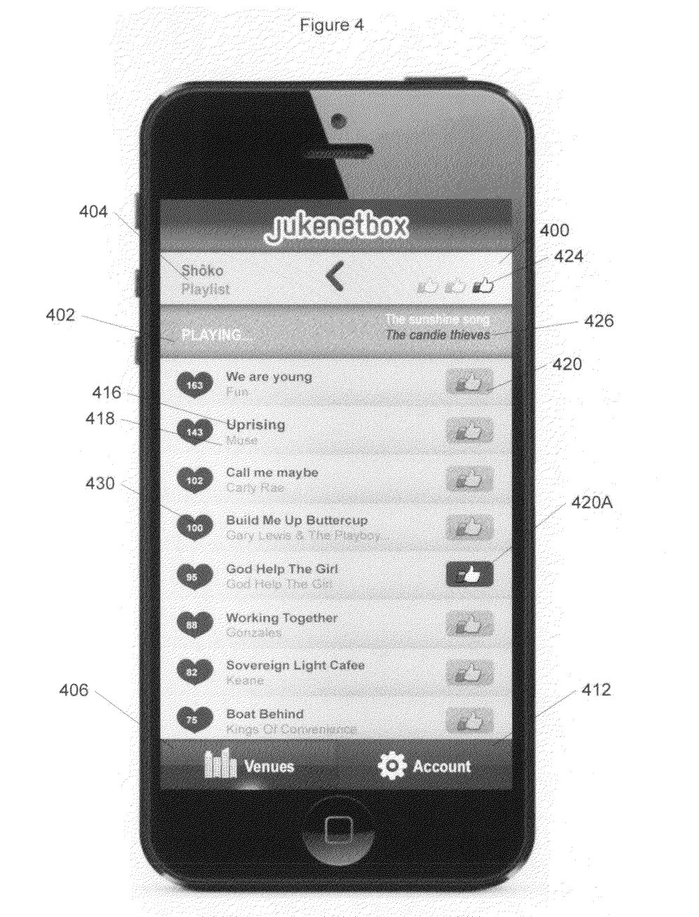

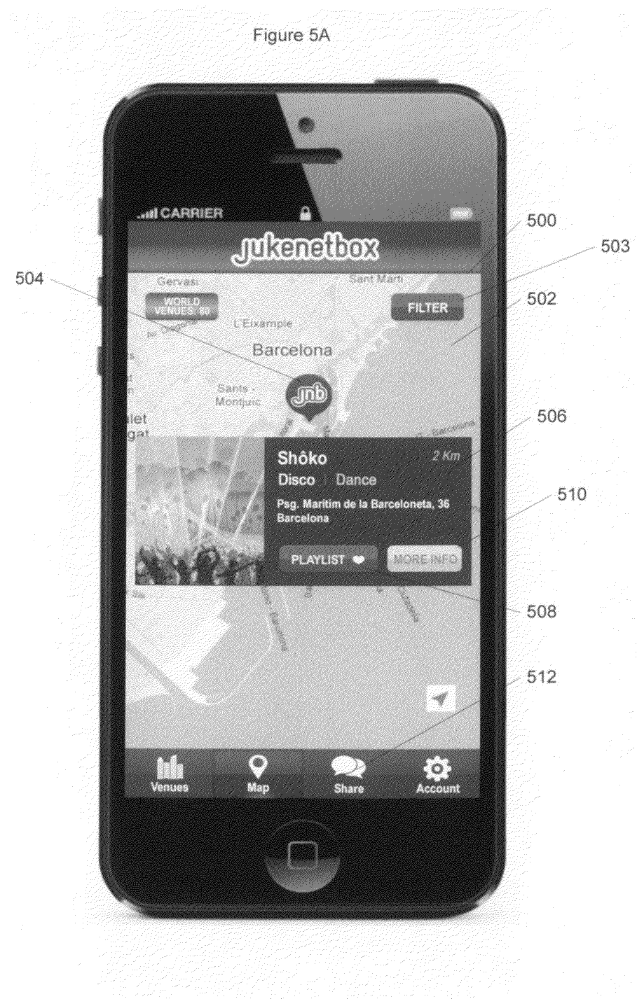

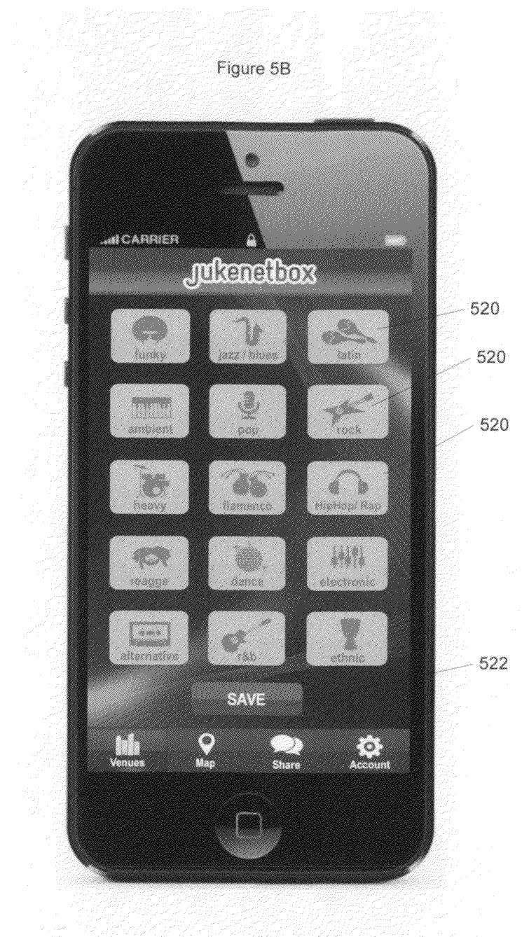

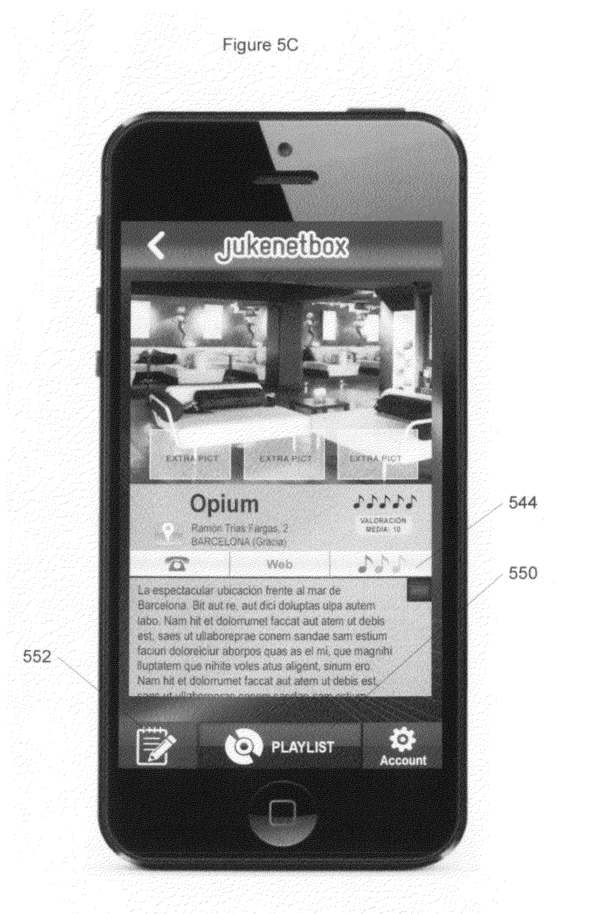

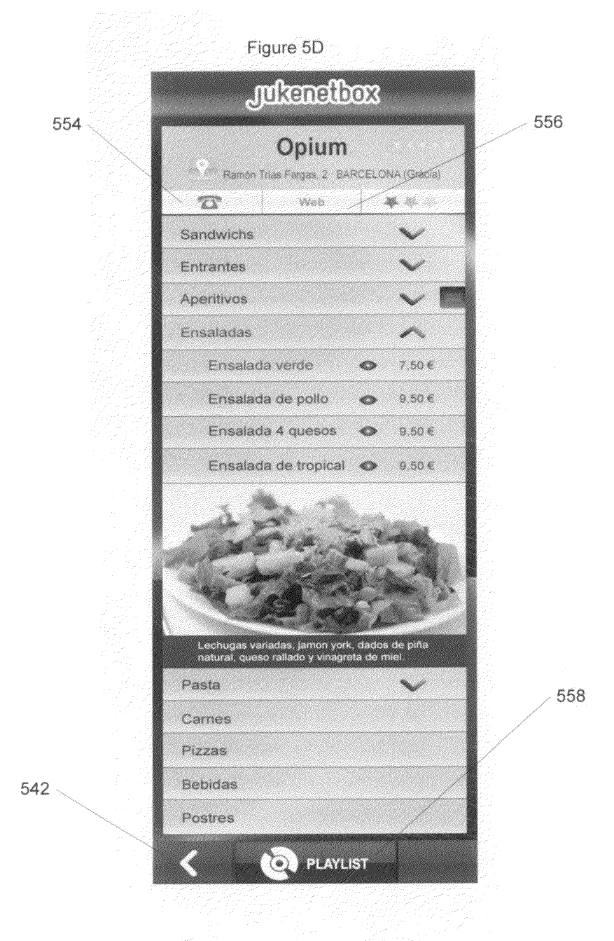

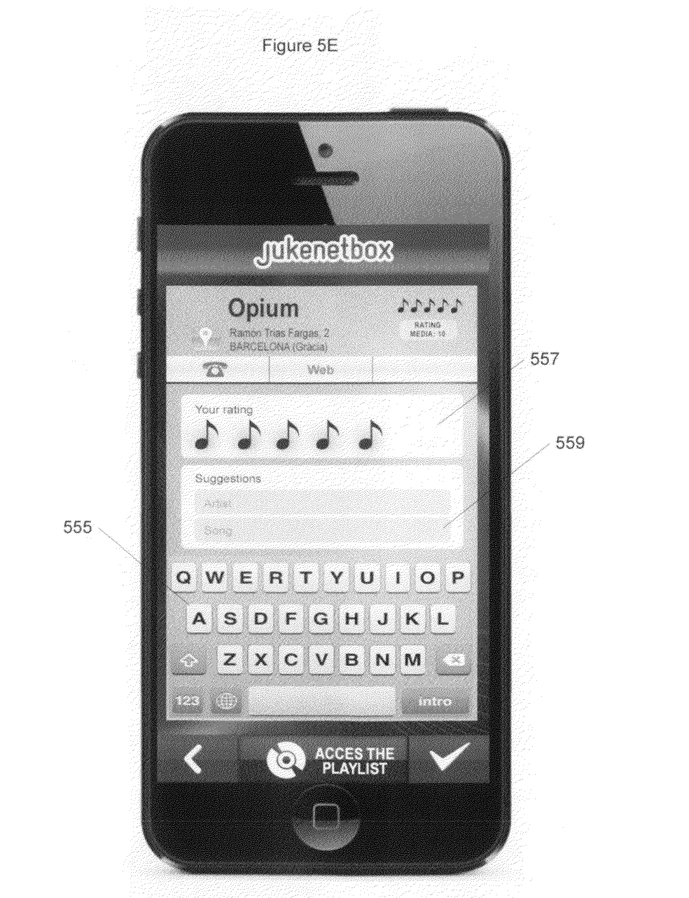

Each Venue has its own label 300A-300C etc., as shown. Each label 300 may include basic information 304 about the Venue including the name of the Venue, type of Venue (e.g., restaurant, bar, club, gym etc.), type of music played (Jazz, Disco, Ambient, etc.) and the address of the Venue. The user's distance from the Venue is shown in area 303. The Venues are arranged by distance from user such that the Venue closest to the user is at the top of the list. Each label 300 may also include an image 302 associated with the Venue. Clicking button 335, the user is presented with a screen such as that shown in FIG. 5b allowing the user to filter Venues by music genre and/or Venue type. Clicking on Venue label 300A, for example, the user is provided with additional information regarding the Venue (see FIG. 5C). The user can review Venue details and then, if they are interested, click Playlist button 550 to view the Venue's playlist (See FIG. 4)

FIG. 4 depicts a Playlist screen 400 according to an embodiment of the present disclosure. The name of the Venue 404 is displayed at the top of the screen. Playlist portion 402 of the screen includes a list of songs available to be played at the Venue and which can be voted on if the user is close enough to the Venue. The playlist includes the name 416 and performer 418 of the ranked song. Of course, additional information can be displayed (e.g., year song was released, song writer, label, etc.) Next to each ranked song is a voting box 420. The songs will climb the playlist based on the overall number of votes the song has received from the patrons. The number of votes each song has received is shown at 430. According to an embodiment of the present disclosure, clicking on box 420 will highlight the box (e.g., see box 420A) indicating that the song has been voted on. According to this embodiment, a user can vote a specified number of times (e.g., 3 times) over a specified voting period of time (e.g., every three minutes) and cannot vote for the same song within the same voting period. Accordingly, in order to vote for the same song, a user waits the specified voting period and then can vote for the same song again. The number of songs voted for during the voting period may be displayed in area 424. After the user has voted for their three songs as indicated by three highlighted “thumbs up” symbols in area 424, area 424 can display a countdown clock counting down the time (e.g., three minutes) until the user can vote again. The song that is presently playing remains at the top 426 of the list and is highlighted as shown. The song will remain highlighted at the top of the list until the song ends at which time the song's vote count is reset to zero and the song is moved to the bottom of the playlist. The list of songs is displayed in descending order based on the number of votes the song has received. That is, the song having the most votes appears at the top of the list and the song with the least number of votes will appear at the bottom of the list.

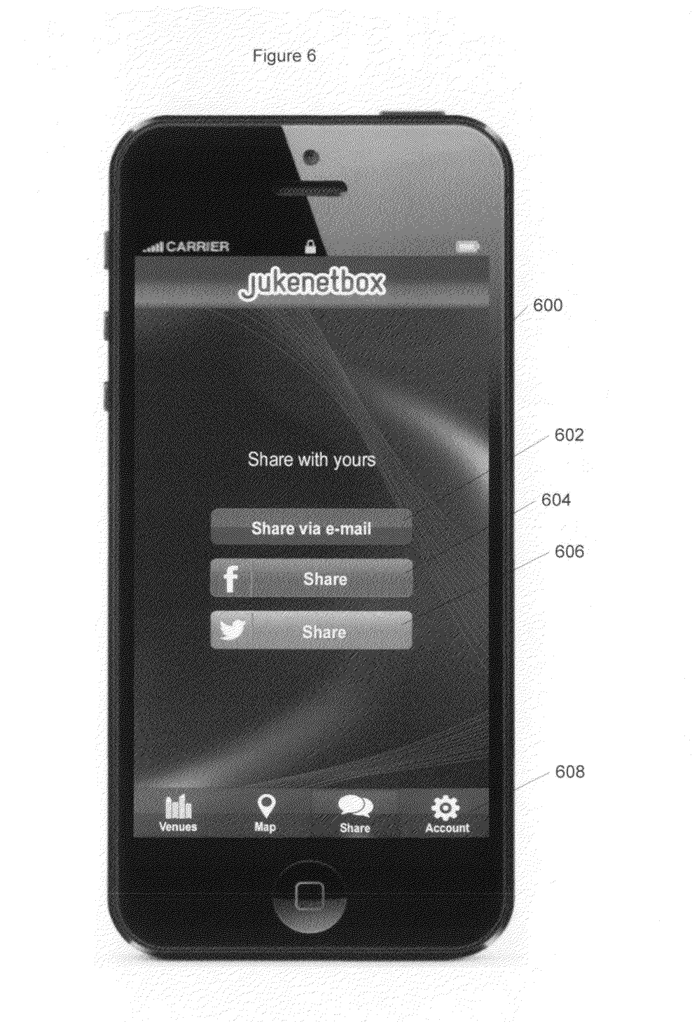

Clicking Venues button 406, the user is returned to Venue list screen shown in FIG. 3A. Clicking Map button 333 (FIG. 3A), the user is presented with a screen 500 as shown in FIG. 5A. This screen is a map of Venues. According to an embodiment of the present disclosure, using geo-localization and GPS information from the user's phone, Venues in the user's vicinity utilizing embodiments of the present disclosure are located and displayed on a map 502. The user can select the type of music/Venue they search for by clicking filter button 503. Upon clicking button 503, the user is presented with a screen such as that shown in FIG. 5B. The user can select from various types of music/Venues by clicking buttons 520. Clicking Save button 522 will save those user preferences for future use when searching Venues. Clicking on a Venue's marker 504 (FIG. 5A) will display information 506 relating to that Venue. The user can then click playlist button 508 to view the Venue's playlist. Clicking button 510 (or image 304, FIG. 3A), the user is presented with a screen such as that shown in FIG. 5C allowing the user to view additional information about the Venue. Clicking Share button 512 (FIG. 5A), the user is presented with a Share screen 600 such as that shown in FIG. 6.

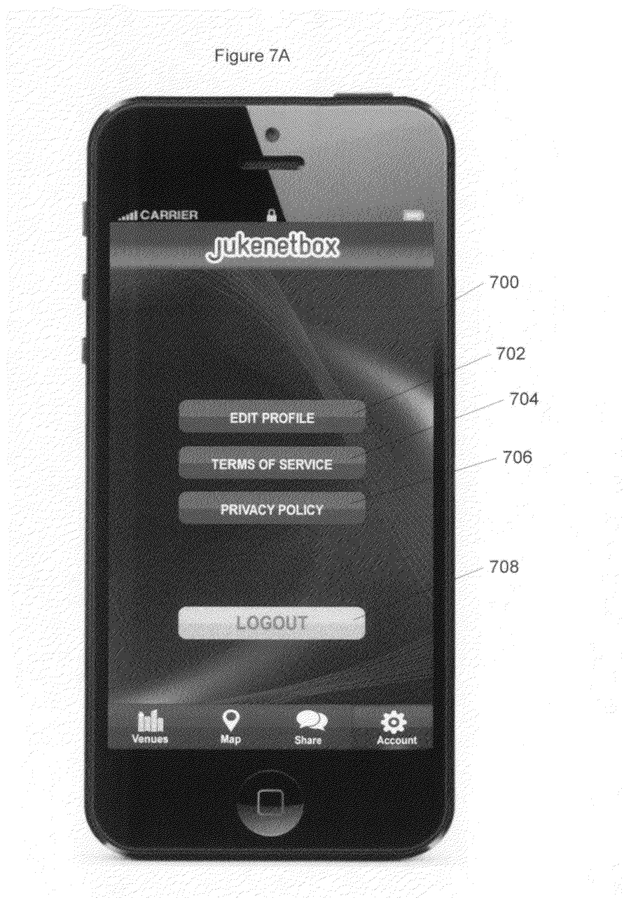

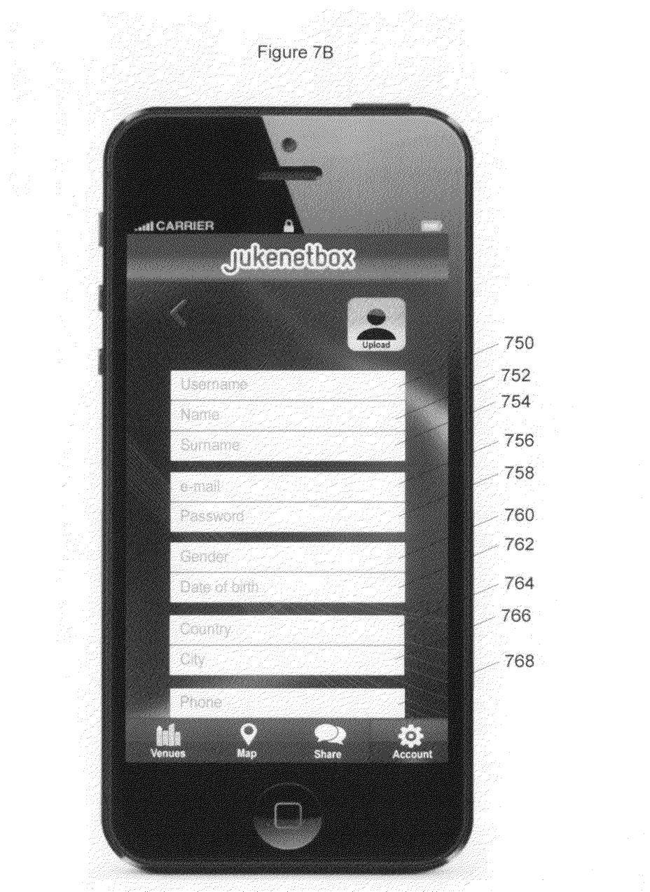

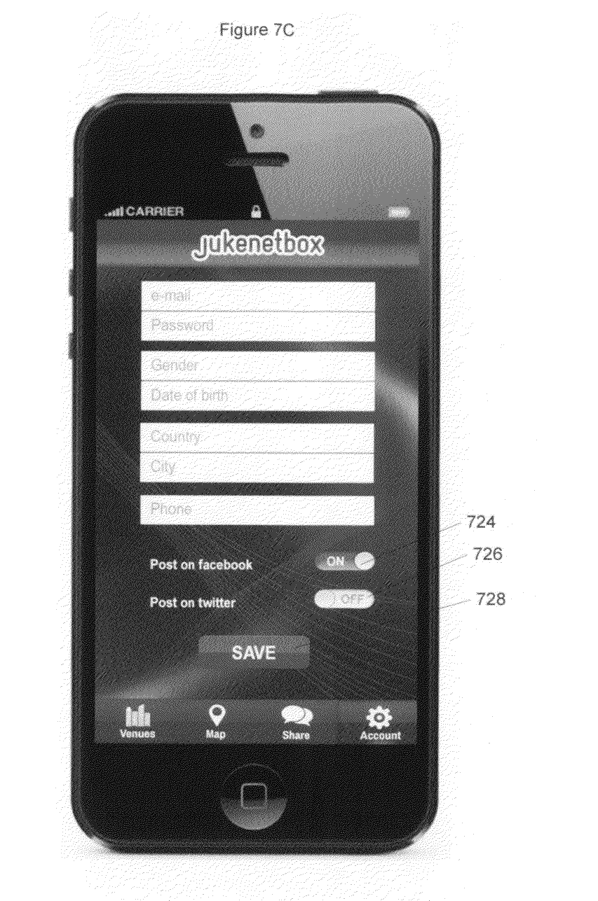

From the Share screen shown in FIG. 6, users can share the songs they voted for and Venue by email (button 602), Facebook (button 604), Twitter (button 606), etc. promoting song, Venue and aspects of the present disclosure. Clicking Account button 608, the user is presented with an Information screen 700 such as that shown in FIG. 7A.

From the Information screen shown in FIG. 7A, users can edit their profile (button 702), consult the terms of service (button 704) and the site's privacy policy (button 706) or logout (button 708.) Upon clicking Edit Profile button 702, the user is presented with a User Profile screen such as that shown in FIG. 7B. The User Profile information may include User Name 750, Given Name 752, Surname 754, Email Address 756 and Password 758. The user profile information may also include Gender 760, Date of Birth 762, Country 764, City 766 and Phone Number 768. Scrolling down (see FIG. 7C), the user is given the option to automatically post their song selections on Facebook using slide button 724 and/or Twitter using slide button 726. Clicking Save button 728 saves the user profile information.

Clicking button 552 (FIG. 5C), the user is presented with the Venue's menu as shown in FIG. 5D. This screen allows the user to access contact information for the Venue by clicking button 554 or to visit the Venue's website by clicking button 556. The user can also access the Venue's playlist screen (FIG. 4) by clicking button 558. Clicking Back button 542 returns the user to the Venue screen (FIG. 5C).

Returning to the Venue screen shown in FIG. 5C, clicking on button 544, the user can input ratings and music suggestions for that Venue utilizing a screen such as that shown in FIG. 5E. From this screen, the user can rate the Venue on a scale of 0-5 musical notes in box 557. The user can also make music suggestions to the Venue using area 559 and keypad 555.

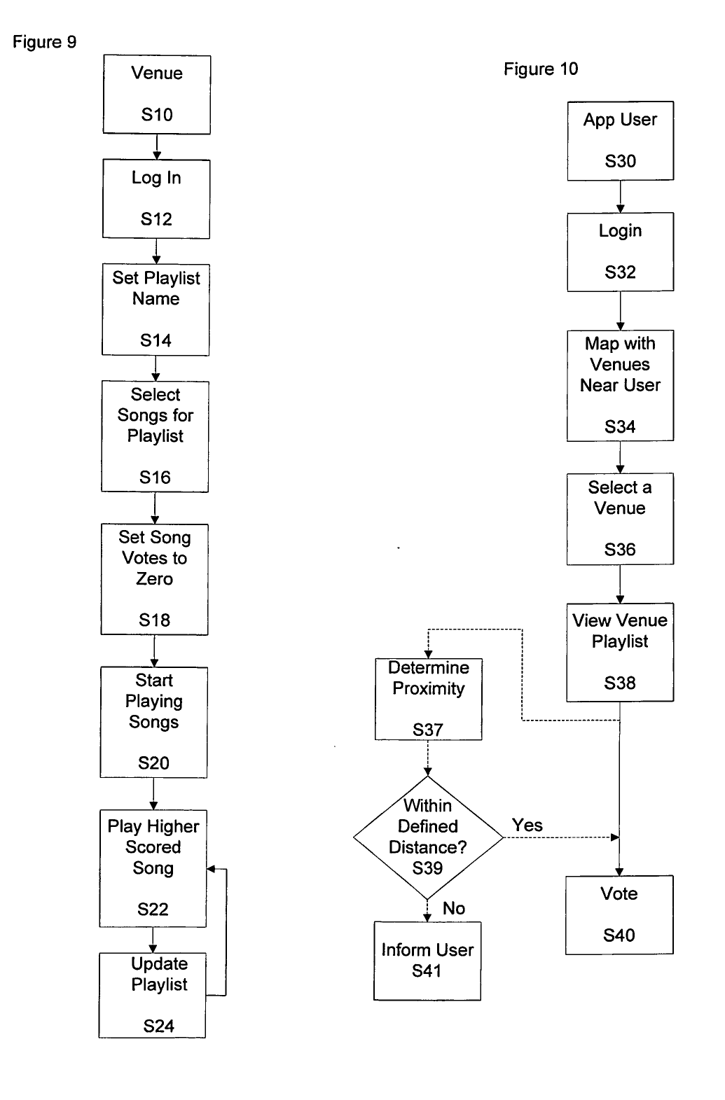

FIG. 9 is a flowchart depicting steps performed by Venues according to an embodiment of the present disclosure. The manager or person otherwise in charge of the music at the Venue, first logs onto the website (Step S12) to start a new Playlist. The manager then names the playlist (Step S14) and selects songs or tracks to put into the playlist (Step S16). The voting score for all songs is set to zero (Step S18). The music starts playing beginning with whatever song is at the top of the playlist (Step S20). As songs receive votes, the order of the playlist is automatically updated so that the song having the most votes moves to the top of the playlist and is played next (Step S22). The order of the playlist can be periodically updated (e.g., every 3 seconds) (Step S24). Steps S22 and S24 are repeated so that the most voted for songs are played prior to the less voted for songs. According to an embodiment of the present disclosure, once a song has played, it's score is zeroed out and it is moved to the bottom of the list and will not be played again for a specified period of time (e.g., 20 minutes) even if it has received the most votes. This prevents the same song from being played too many times in a short period of time. Of course, the system can be arranged such that after a song is played, it's score is zeroed out and can move to the top of the list and be played as soon as it has received a sufficient number of votes.

FIG. 10 is a flow chart depicting steps performed by users (e.g., patrons) of the Venue. Once the user has downloaded the user app (Step S30), the user can login to the system (Step S32). The user is then presented with a map including Venues in close proximity to the user utilizing aspects of the present disclosure. The map is displayed on the user's device (Step S34). Once a user has selected a Venue (Step S36), the Venue's playlist is displayed on the user's device (Step S38). The user can then vote for the song or songs they would like to listen to. According to an embodiment of the present disclosure a user can vote for a specified number of songs (e.g., up to three songs) over a specified period of time as configured by the system (e.g., every three minutes) (Step S40.) According to an embodiment of the present disclosure, prior to allowing the user to vote, the user's proximity to the Venue is determined (Step S37). If within a defined distance of the Venue (Yes, Step S39), the user is allowed to vote (Step S40). If not within the defined distance of the Venue (No, Step S39) the user is informed that they cannot vote for songs on the downloaded play list unless they are within a defined distance of the Venue (Step S41.)

FIG. 13A is a Venue Playlist screen according to an embodiment of the present disclosure. The Venue can manage their playlist(s) from this screen. The Venue can create a playlist by clicking New Playlist button 806 which will, for example, display the PC's file explorer where songs can be selected. Selected songs will be added to the playlist shown in area 802. Area 804 shows the song currently playing. Songs can be removed from the playlist by clicking Remove button 801. The Venue can add a new playlist by clicking button 806. The Venue can enter a name for the playlist in area 808. Pause button 810A, Stop button 810B and Fast Forward button 810C allow the Venue to control the song being played. Slide control 812 controls the volume and Cross Fade slide control 814 allows songs to be faded in and out as desired. Bar 816 shows length of the song playing and indicates what portion of the song is currently playing and how much of the song remains. Clicking Profile button 818, the Venue is presented with a profile screen such as that shown in FIG. 13B for managing their profile. Entering their email (Box 820) and a new password (Box 822) and clicking change button 831 will update the Venue's login password. The Venue should enter all the requested data to ensure correct registration so users can locate the Venue. This information can include Venue Name (824), Venue Continent (826), Venue Country (828), Venue City (830), Venue Address (832), Venue Type (834) and Venue Music type (836). The Venue can also enter a description in box 838 and should position their Venue using map 840. Area 842 allows the Venue to enter one or more images to associate with their Venue. Clicking Submit button 844 enters the information into the system. Returning to FIG. 13A, clicking on DJ mode button 860, allows the system to be utilized in a Disk Jockey (DJ) mode and will display a screen such as that shown in FIG. 13C.

According to this embodiment of the present disclosure, DJ mode allows DJs to know in real time what their listeners would like to hear but still maintain control over what is actually playing. According to this embodiment, the profile information (button 863) should be updated each time the DJ's Venue changes so that users can be correctly geo located by the App. The DJ enters a Playlist in area 862 in a manner similar to that described above with respect to FIG. 13A. Users then access the playlist and vote for songs in a manner similar to that described above. However, according to this embodiment, the songs are not played automatically in order based on the number of votes. Instead, the DJ can choose to play the top rated songs from list 862 at any time they deem appropriate in the set of music being played. Of course, the DJ can choose to not play a particular song if so desired. When the DJ plays a song on the list, the DJ clicks on a fast forward button 864 to manually zero out the number of votes for that song. The song then moves to the bottom of the playlist.

Systems (e.g., hardware and/or software) are available that are capable of listening to music and determining the title of the song being played. Such systems can be utilized by embodiments of the present disclosure. For example, in DJ Mode, once a song at the top of the list is played and is detected by the system, the song will be automatically zeroed out and moved to the bottom of the list thus alleviating the burden on the DJ from having to remember to always perform that task.

According to an embodiment of the present disclosure, playlists can be sourced from cloud streaming. For example, the client logs on to a third party music streaming service (for example Spotify) offering embodiments of the present disclosure through their platform. From within this platform the client then accesses the present system by entering their user ID and Password. According to another embodiment of the present disclosure, the client can enter the third party music streaming company's site directly from a website logon page similar to that shown in FIG. 1. Once the client is logged on, the playlist is compiled from the music offered by the third party music streaming company. The user enters their mobile app, finds the Venue and commences voting for songs on the Venues playlist, as described above.

According to another embodiment of the present disclosure, a voting system can be utilized for private parties in the client's home (e.g., for birthday parties, wedding receptions, barbeques, etc.) The client receives an ID and password and logs on through the clients area on the web site. After entering the ID and password, a Playlist page will be shown and music can be selected to compile the playlist for the Private Party. In this embodiment, since the client is not a business, only the playlist tab is needed; no photos, Venue address or description is needed.

The party guests will enter the mobile app and from the Venue list screen (FIG. 3A), click on the “Private Party” button 337. The party guest is then provided with a screen such as that shown in FIG. 3B. Party guests then enter the code provided to the private party client in box 360 and click Done button 362. The guest will then be shown the playlist where they can commence voting.

Radio Stations can utilize embodiments of the present disclosure, enabling their listeners to choose what is played on air. The only difference with this system compared to that of traditional clients; bars, hotels, restaurants etc. where the client has a restricted geographical voting radius, the Radio Station has no geographical voting boundaries so their listeners can vote from anywhere in the world. Within the mobile app there is a search page for users, enabling the selection of Venue by type. When the user selects “Radio Station” the application will show a list of all radio stations using the present system, upon selecting a radio station their playlist will be shown and the user can vote for their preferred songs.

Through use of the present system, the radio station will be able to view in real time what the listeners have voted for and leave the system automatically play the most voted for songs, or they can use the system in DJ mode playing the most voted for songs manually.

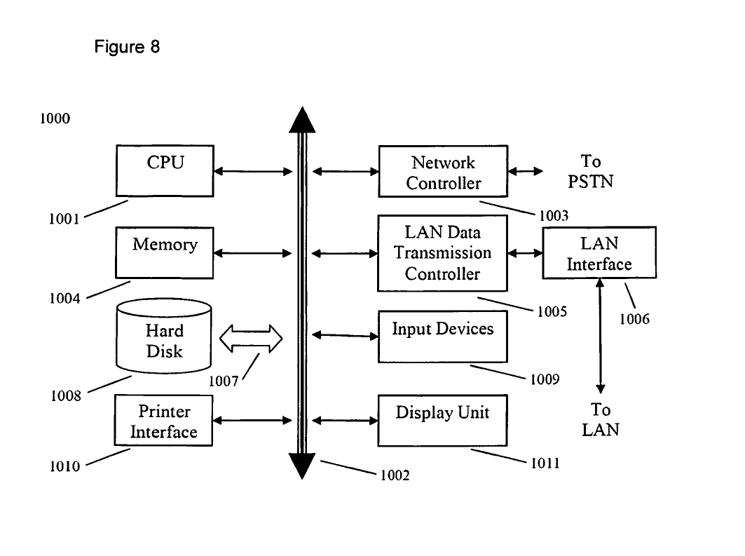

FIG. 8 shows an example of a computer system 1000 which may implement aspects of the method and system of the present disclosure. Aspects of the system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 1000 can include a central processing unit (CPU) 1001, program and data storage devices 1004, a printer interface 1010, a display unit 1011, a (LAN) local area network data transmission controller 1005, a LAN interface 1006, a network controller 1003, an internal bus 1002, and one or more input devices 1009 (for example, a keyboard, mouse etc.). As shown, the system 1000 may be connected to a database 1008, via a link 1007.

The computer system 1000 is merely exemplary. The specific embodiments described herein are illustrative, computer system(s) as referred to herein may include(s) individual computers, servers, computing resources, networks, etc., and many variations can be introduced on these embodiments without departing from the spirit and or scope of the disclosure.

The present disclosure thus provides a unique, revolutionary online system that changes the way in which users interact with their favorite Venues (bars, pubs, restaurants, clubs, hotels . . . ) that is easy to implement through smartphones, tablets, etc., creating an international social network of reference that specializes in music. Embodiments of the present disclosure provide a modern substitute to the traditional Jukebox, since it gives people as a group the right to decide which music to listen to in a shared space. Embodiments of the present disclosure also give users complete freedom to choose the music they want to hear while also respecting the musical style of each Venue.

Whereas the Jukebox functioned in a mechanical and individual manner (users chose the song they wanted to hear and it was played, regardless of the tastes of the other users), embodiments of the present disclosure allow all users to vote for songs from among those offered by the Venue in keeping with the Venue's musical style. User's (e.g., patrons) download an app according to an embodiment of the present disclosure onto their mobile device (e.g., smartphone, tablet, etc.) This app allows users to vote for a song or songs from the Venue's playlist which they desire listening to and the songs with the highest number of votes will be heard as they make their way to the top of the playlist.

Various systems may be used to raise reVenue utilizing embodiments of the present disclosure. For example, a license fee (e.g., fixed, weekly, monthly, yearly, etc.) may be charged to each establishment for use of embodiments of the present disclosure. The license fee may be based on the seating capacity of the establishment in which the present system will be utilized.

The present systems and methods can be implemented in digital electronic circuitry, or in computer hardware, firmware, software, or in combinations of them. The systems and methods can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with embodiments of the present disclosure can be performed by one or more programmable processors executing a computer program to perform functions of the invention by operating on input data and generating output. Method steps can also be performed by, and apparatus of the present disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, the embodiments of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The system can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the invention, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other. A computer program can be deployed to be executed on one computer or on multiple computers at one site or distributed across multiple sites and interconnected by a communication network. The computer program may be run on a smart phone using the Android or Apple operating system. The computer program may be in the form of an App such as a native app, mobile web app or web app, including, for example, native IoS mobile app

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A method of providing music comprising:
creating a playlist of songs capable of being played at an establishment, the playlist accessible via a wireless network by users;
providing users with access to the playlist of songs via the wireless network;
receiving user votes via the wireless network indicating which songs from the playlist of songs users desire to hear; and
updating an order of songs to be played at the establishment based on the user votes.

2. The method as recited in claim 1, wherein the songs capable of being played at the establishment are available via interne streaming.

3. The method as recited in claim 1, wherein the wireless network comprises at least one of a cellular network and the Internet.

4. The method as recited in claim 1, wherein each user can vote for a predetermined number of songs from the playlist within a predetermined period of time.

5. The method as recited in claim 4, wherein the predetermined number of songs is three.

6. The method as recited in claim 4, wherein the predetermined period of time is three minutes.

7. The method as recited in claim 1, further comprising determining a location of the user relative to the establishment, wherein a user is allowed to vote for a song only if they are within a predetermined distance from the establishment.

8. The method as recited in claim 1 wherein the playlist comprises for each song at least one of a name of the song, a name of an artist associated with the song and a number of votes cast for the song.

9. The method as recited in claim 1, wherein the order of songs is arranged in descending order with a song having a most number of votes at a top of the playlist and the song with a least number of votes at a bottom of the playlist.

10. The method as recited in claim 9, wherein a song at the top of the playlist is automatically played at the establishment.

11. The method as recited in claim 9, wherein a song at the top of the playlist is not played at the establishment until desired.

12. A system of providing music comprising:
a system for creating a playlist of songs capable of being played at an establishment, the playlist accessible via a wireless network by users;
a system for providing users with access to the playlist of songs via the wireless network;
a system for receiving user votes via the wireless network indicating which songs from the playlist of songs users desire to hear; and
a system for updating an order of songs to be played at the establishment based on the user votes.

13. The method as recited in claim 12, wherein the songs capable of being played at the establishment are available via interne streaming.

14. The method as recited in claim 12, wherein the wireless network comprises at least one of a cellular network and the Internet.

15. The method as recited in claim 12, wherein each user can vote for a predetermined number of songs from the playlist within a predetermined period of time.

16. The method as recited in claim 15, wherein the predetermined number of songs is three and the predetermined period of time is three minutes.

17. The method as recited in claim 12, further comprising determining a location of the user relative to the establishment, wherein a user is allowed to vote for a song only if they are within a predetermined distance from the establishment.

18. The method as recited in claim 12, wherein the playlist comprises for each song at least one of a name of the song, a name of an artist associated with the song and a number of votes cast for the song.

19. The method as recited in claim 1, wherein the order of songs is arranged in descending order with a song having a most number of votes at a top of the playlist and the song with a least number of votes at a bottom of the playlist.

20. The method as recited in claim 19, wherein a song at the top of the playlist is not played at the establishment until desired.
